(19) United States
(12) Patent Application Publication
(10) Pub. No.: US 2015/0026583 A1
(43) Pub. Date: Jan. 22, 2015

(54) MEDIA CONTENT BOARDS

(71) Applicant: EchoStar Technologies L.L.C., Englewood, CO (US)

(72) Inventor: Jason Anguiano, Castle Rock, CO (US)

(73) Assignee: EchoStar Technologies L.L.C.

(21) Appl. No.: 13/943,316

(22) Filed: Jul. 16, 2013

(51) Int. Cl. H04L 29/08; G06F 3/0484

(52) U.S. Cl. CPC H04L 67/02; G06F 3/0484
USPC 715/738; 709/219

(57) ABSTRACT

A system, comprising a media device that includes a processor and a memory, is configured to receive from a first remote site a first set of data concerning a plurality of items of media content. Each of the plurality of items of media content is determined at the first remote site at least in part according to a descriptor provided from the first media device and data from a second remote site. The media device is configured to display a graphical user interface identifying each of the plurality of items of media content.

### BACKGROUND

Media content, such as video presentations, audio presentations, movies, television programs, etc., may be provided to a consumer in a variety of ways. For example, a video, movie, or television show may be provided via the Internet, e.g., from providers such as Netflix, YouTube, Hulu, etc., or via a proprietary delivery system maintained by a satellite or cable television provider. Moreover, a consumer may consume content using one or more of a television, set-top box, personal computer, tablet computer, smartphone, etc. Accordingly, an item of media content such as a movie may be presented to many different consumers via a variety of mechanisms.

Regardless of how the media content is presented, consumers of media content may share viewing preferences. Further, consumers of media content may find other consumers' preferences, e.g., preferences of celebrities, friends, acquaintances, etc., to be of interest. However, consumers may have difficulty in locating media content that suits their preferences, or that is known to be of interest to certain other consumers of media content. Indeed, mechanisms are presently lacking for consumers to identify and share content that is preferred, likely to be of interest, etc.

### DRAWINGS

FIG. 1 a block diagram of an exemplary content delivery system.

FIG. 2 is a diagram of an exemplary process for a content board application to obtain user data.

FIG. 3 is a diagram of an exemplary process for obtaining data related to items of media content.

FIG. 4 is a diagram of an exemplary process for use of user data received from a content board server.

### DETAILED DESCRIPTION

### System Overview

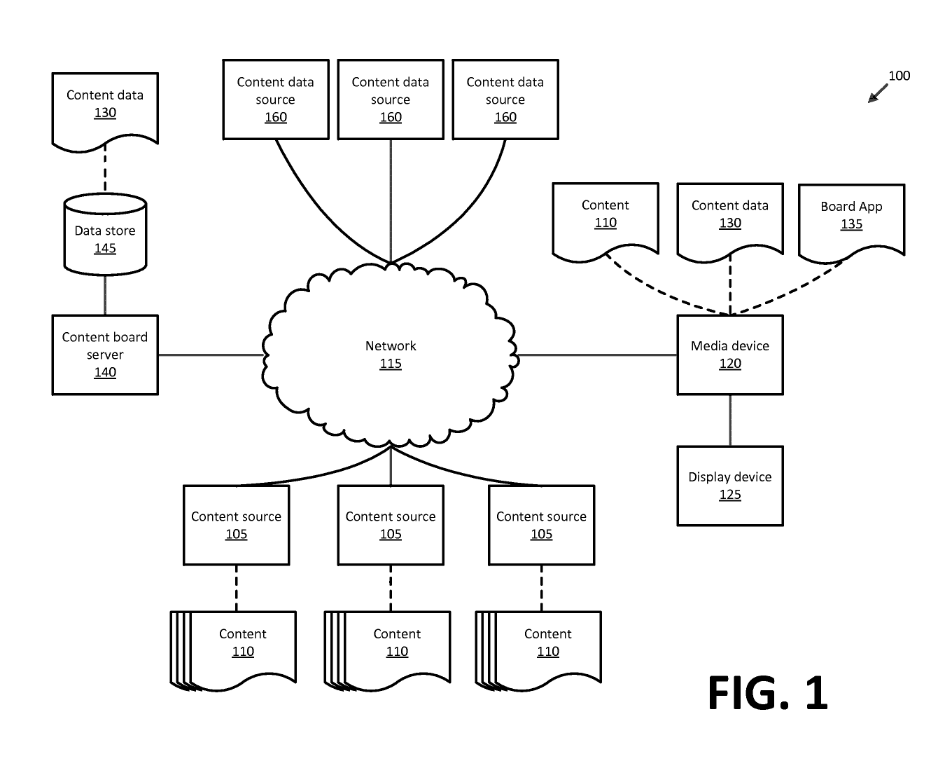

FIG. 1 is a block diagram of an exemplary content delivery system 100. One or more media content sources 105 each store one or more instances of media content 110, e.g., audio and/or video. The content 110 may be provided via a network 115 to a media device 120. Further, the content 110 may be displayed to a user via the media device 120 and/or a media display device 125 such as a television, video monitor, or the like. The media device 120, e.g., a computer, set-top box, etc., provides media content 110 to a display device. Memory or other storage media of the media device 120 may include media content 110 metadata such as content data 130, e.g., data relating to content 110 identified, preferred, and/or shared by a user. The media device 120 generally also includes a content board application 135 through which a user may identify and/or share media content 110. A media content board server 140, and generally and an associated data store 145, may store content data 130 for a plurality of users to facilitate sharing of information, including preferences, concerning media content 110 amongst a plurality of users.

### Exemplary System Elements

A media content source 105 may be any one, or some combination, of various mechanisms for delivering media content 110, and may depend on a type of media content 110 being provided. By way of example and not limitation, media content 110 data may be provided as video-on-demand through a cable, satellite or internet protocol television (IPTV) distribution system, as streaming Internet video data (e.g., from a site such as Netflix, YouTube, Hulu, etc.), or as some other kind of data. Further for example, the media content source 105 could be a computer readable medium included in or accessible by the media device 120, e.g., an optical disc such as a DVD (sometimes referred to as a digital video disk) or Blu-ray™ disc, etc. In general, examples of media content 110 include various types of data, including audio, video, images, etc. Accordingly, examples of content sources 105 may include one or more of a cable or satellite television head end, a video streaming service such as generally includes a multimedia web server (or some other computing device), or some other mechanism for delivering multimedia data.

Media content 110 is generally delivered via the network 115 in a digital format, e.g., as compressed audio and/or video data. For example, MPEG refers to a set of standards generally promulgated by the International Standards Organization/International Electrical Commission Moving Picture Experts Group (MPEG). H.264 refers to a standard promulgated by the International Telecommunications Union (ITU). Accordingly, by way of example and not limitation, media content 110 may be provided in a format such as the MPEG-2 or the H.264/MPEG-4 Advanced Video Coding standards (AVC) (H.264 and MPEG-4 at present being consistent), or according to some other standard or standards. For example, media content 110 could be audio data formatted according to standards such as MPEG-1 or MPEG-2 Audio Layer III (MP3), Advanced Audio Coding (AAC), etc. Further, the foregoing standards generally include support for metadata. Content 110 using a standard or standards that do not explicitly include provisions for metadata, or standards that have limitations on metadata size, may be supplemented with discrete metadata (e.g. separate files) which uses either embedded metadata or information such as timecodes/time stamps/timing intervals which can be used to modify the standard content 110. Content 110 metadata generally includes indexes, pointers, or other mechanisms for identifying locations in media content 110.

The network 115 represents one or more mechanisms for delivering content 110 from a content source 105 to a media device 120. Accordingly, the network 115 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks, local area networks (LAN) and/or wide area networks (WAN), including the Internet, providing data communication services.

The media device 120 is generally a device including a computer processor and associated storage, e.g., volatile memory and/or nonvolatile memory, etc., and capable of communicating via the network 115 and playing content 110. Exemplary media devices 120 include a set-top box, a personal computer such as a laptop, handheld, or tablet computer, a smart phone, etc. Further, the media device 120 may be connected to a separate display device 125, e.g., a monitor or television, or may incorporate a display device 125, e.g., a display of a tablet or personal computer media device 120. When content 110 is referred to herein as being “displayed” it is to be understood that such display could include any possible mode of displaying media data, such as a display of visual data, audio data, etc. For example, content 110 could be displayed by showing video or image data on a screen with or without sound, by playing audio data with or without a visual display, etc.

As mentioned above, a memory or other storage medium in the media device 120 may include content data 130, which in turn may be collected at least in part by execution of the content board application 135. As discussed further below, a larger and/or different set of content data 130 is generally also stored in the data store 145 associated with the server 140. A set of content data 130 generally relates to multiple items of media content 110, and may include a variety of fields. For example, content data 130 generally includes a unique or substantially unique identifier for each item of media content 110 included in the content data 130.

The content data 130 generally also includes descriptors, sometimes referred to as attributes or tags, associated with one or more items of media content 110. To provide just a few examples from many possible, a descriptor for an item of media content 110 could include a category or genre (e.g., honor, comedy, etc.), a name of an actor, director, producer, or other person associated with the item of media content 100, a name or identifier for a critic, or another user, who gave the media content 110 a good (or bad) rating, a descriptor for an appropriate audience (e.g., “kid-friendly”), etc. Further, content data 130 generally includes names and/or other identifiers of users who have tagged, e.g., recommended, rated, etc. the item of media content 110.

Content data 130, including descriptors or the like, may generally be thought of as metadata with respect to one or more items of media content 110. A descriptor in content data 130 may be used to group or associate two or more items of media content 110. For example, a descriptor could include the words “Must see,” and could then be associated with each of a plurality of items of media content 110 (e.g., at least first and second items of media content 110) such as movies or video programs. Then, the content board application 135 could be used to generate a display of media content 110 according to a grouping indicated by a descriptor in the content data 110, e.g., “Must see,” “Zach's favorite Walking Dead episodes,” “Greatest all-time comedies,” etc.

Content data 130 may also identify groups of items of media content 110. For example, groups of items of media content 110 may be associated, e.g., according to their unique or substantially unique identifiers, with a unique or substantially unique content group identifier in the data store 145, e.g., such identifier may be generated via a known mechanism for creating identifiers and then used for storing and retrieving the content 110 group.

Further, as discussed in more detail below, a group of content 110, e.g., as may be represented under a descriptive heading in a GUI provided by a media device 120 along with a set of links to items of media content 110 in the group, may be created and/or modified in a variety of ways. For example, the server 140 may include instructions for associating various records of content data 130, e.g., according to identical or similar descriptors, such that a group identifies a category of content 110, e.g., the server 140 could group together under the group heading “My Friends' Favorite Comedies” movies having descriptors such as “hilarious,” “very funny,” etc. Further, a user of a media device 120 could specify, e.g., via a GUI provided by the media device 120, possibly via a webpage or the like from the server 140, one or more groups of content 110. For example, the user could specify “Jim's Favorite Horror Films,” etc., whereupon this group heading and a set of media content items 110 (e.g., a set of scary movies) could be sent to the server 140 and stored in content data 130 in association with a group identifier. Further, a user could specify other users with whom such group may be shared, or users to share groups could be identified via other mechanisms, whereupon such sharing relationships could also be stored in the content data 130.

In general, the content board application 135 includes instructions stored in, and executable by a processor of, the media device 120. For example, the content board application 135 may include instructions for generating a graphical user interface (GUI) and/or GUI components that may be overlaid on, or displayed alongside, media content 110, such GUI or GUI components thereby being provided to a user via the display 125.

Further, the application 135 may include instructions for obtaining user input with respect to an item of media content 110. For example, a user could indicate a “like” or “dislike” of an item of media content 110, such as a movie, television program or the like, etc. Similarly, a user could rate an item of media content 110, e.g., on a scale of 1 to 10, a scale of 1 to 5 stars, etc. Moreover, a user could indicate a descriptor, e.g., a tag or the like to be associated with the item of media content 110, e.g., a category such as sports, history, drama, comedy, science-fiction, the name of an actor or director, “suitable for kids,” etc. As mentioned above, the application 135 could use descriptors to display listings of items of media content 110 according to groupings indicated by the descriptors.

The server 140 may be one or more computer servers, generally including at least one processor and at least one memory, the memory storing instructions executable by the processor, including instructions for carrying out various of the steps and processes described herein. For example, the server 140 generally includes instructions for gathering and storing content data 130. The server 140 may receive content data 130 from one or more media devices 120. In addition, the server 140 may gather content data 130 from one or more content sources 105 and/or one or more content data sources 105.

The data store 145 may be included in the server 140 and/or may be a separate computing device. The data store 145, possible examples of which are discussed further below, generally includes computer-executable instructions for storing and managing data, as well as a computer-readable medium for data storage. As mentioned above, the data store 145 generally stores media content data 130 pertaining to a plurality of users and a plurality of items of media content 110.

Content data sources 160 may include virtually any source, accessible via the network 115, of data about an item of media content 110, including a content source 105. For example, content data source 160 may be a known social media provider, such as Facebook, Twitter, MySpace, LinkedIn, Google+, etc. Further, a content data source 160 may be a web site or the like that provides information about items of media content 110, e.g., IMDb.com, Wikipedia.org, etc., just to name a few.

In general, content data 130 may include data associated with a user that is available from a remote site such as a social media data source 160, as well as data about items of media content 110, such as may be available from a content source 105 and/or a content data source 160. User data 130 may include data accessed from a user account on a remote site and/or data accessed about a user from the remote site. For example, social media data sources 160 such as Twitter, Facebook, LinkedIn etc., may provide data 130 associated with a user without requiring a log-in to a user's account Likewise, other remote sites may allow for access to user data 130, e.g., e-commerce sites such as Amazon.com, Netflix, IMDb.com, Wikipedia.org, etc., may provide data 130 about a user variously with or without requiring a login to the user's account on the remote site.

In addition, content data sources 160 may receive content data 130, e.g., a user may specify from a device 120, or may provide instructions for the server 140, to provide content data 130 to a social media data source 160. For example, a set of links of items of media content 110 may be provided to a data source 160, generally along with associated descriptors, e.g., a Facebook “wall” could be updated with a list of “Bob's favorite comedies,” etc.

In cases where a user account is used to obtain data 130, a user account on a content data source 160 can generally be accessed by providing a user login identifier and password. Logging in with such identifier and password generally provides access to data that may be used to populate content data 130. For example, logging in to a user's Facebook account provides access to the user's Facebook page and other account information, including a user's “likes,” posts to the user's and other users' Facebook “walls,” etc. Similarly, logging into a user's Twitter account provides access to other Twitter users that the user is “following.” Further, a Twitter user's login information, or simply information relating to the user's Twitter “handle,” provides a mechanism for following the user's “tweets.”

### Exemplary Process Flows

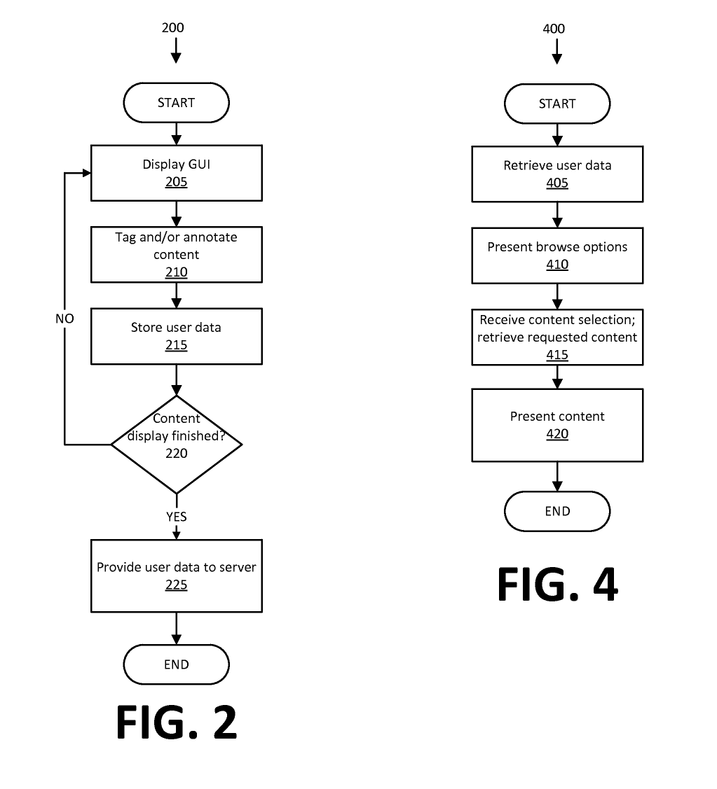

FIG. 2 is a diagram of an exemplary process 200 for the application 135 to obtain content data 130.

The process 200 begins in a block 205, in which the media device 120 displays a graphical user interface (GUI) including one or more lists of media content 110 items that may be displayed according to groups as described above. The GUI could be presented in a variety of ways, e.g., in a webpage, as part of a User Program Guide (UPG) provided by a content provider, etc. The GUI may or may not be displayed while media content 110 is being streamed from a content source 105 and/or displayed from a memory of the media device 120. As discussed above, the media device 120 may be a set-top box or the like, or may be a computing device such as a laptop computer, tablet computer, smart phone, etc. In any event, the media device 120 may be configured to receive media content 110 from one or more content sources 105, e.g., upon a user selection of a television channel, a user selection to download content 110 from a website, etc.

Next, in a block 210, the application 135 may receive user input indicating descriptor such as a tag to be associated with the user and with the particular item of media content 110 in user data 130. For example, the user may access a GUI that may be overlaid on, or displayed alongside, the media content 110, while the media content 110 is being played, or the GUI may be presented separately, such as in an initial UPG screen, a webpage, etc. In any event, the GUI may present a user with options for specifying a tag to be associated with the media content 110 e.g., via a variety of mechanisms, e.g., via keyboard input, a menu of options, etc., for specifying a tag. Accordingly, a GUI could provide one or more lists of media content 110 items that a user could select for association with various tags, inclusion in various groups, etc. Further, the GUI could provide a mechanism for a user to browse for, and/or search for, items of media content that may be of interest, and that the user may wish to associate with one or more tags or one or more groups. Alternatively or additionally, a user could tag an item of media content 110 while the item is being displayed.

Next, in a block 215, the application 135 stores content data 130. The content data 130 is generally stored in the volatile memory of the media device 120, but may also be saved to a non-volatile medium so that content data 130 for a user of the particular device 120 may be stored locally on the device 120, may be later transmitted to the server 140, etc. The content data 130 stored in the block 215 generally includes descriptors, e.g., a tag or tags selected by a user to be descriptive of the media content 110, e.g., “great scary movie,” “hunting show,” an identifier for a content source 105, a rating, a categorization (e.g., “kid-friendly,” “adult,” “comedy”), etc. Further, the application 135 generally includes in the content data 130 an identifier for an item of media content 110 for which a user a provided input, and with which a record or records in content data is to be associated. As mentioned above, descriptors may be used for grouping two or more items of media content 110, e.g., providing list or links to items of media content 110 according to groups indicated by descriptors such as the foregoing tags, categories, etc. The content data 130 may also include other information such as a timestamp or other data to indicate a location in the media content 110 with respect to which the tag was received, identifiers for other items of media content 110 that a user has watched in a predetermined time period (e.g., that day), an annotation provided by a user that can be included in the content data 130 to be shared with other users, etc.

Next, in a block 220, the application 135 determines whether a media content 110 display, initiated as described above with respect to block 205, continues to play or is completed. If the media content 110 is finished, then a block 225 is executed next. Otherwise, the process 200 returns to the block 205.

In the block 225, content data 130 collected as described above with respect to the block 215 is transmitted, e.g., via the network 115, to the content board server 140. The content board server 140 generally stores the content data 130 in an associated data store 145.

Following the block 225, the process 200 ends.

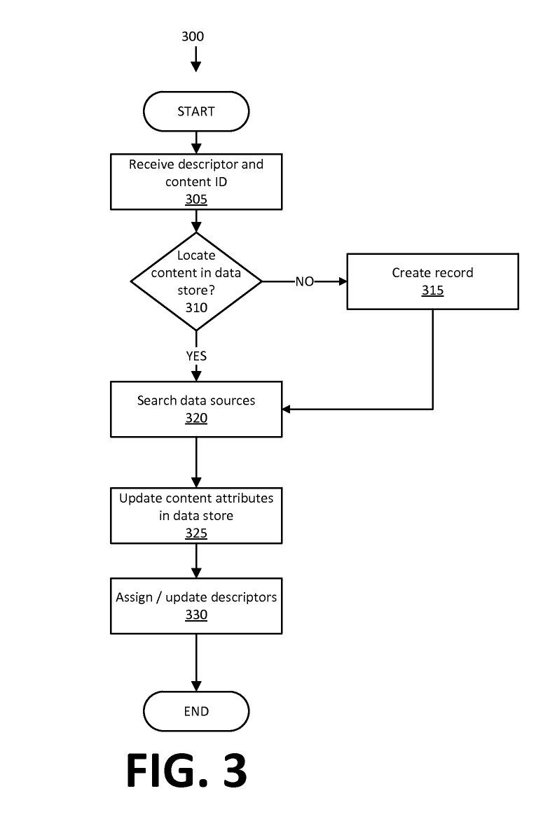

FIG. 3 is a diagram of an exemplary process 300 for the server 140 to obtain content data 130.

The process 300 begins in a block 305, in which the server 140 receives an identifier for an item of media content 110, along with a descriptor, e.g., a tag, annotation, etc., for the item of media content 110. For example, the server 140 could receive one or more new records of content data 130 from a remote site, e.g., a customer premises including one or more media devices 120. The server 140 could query one or more devices 120 on a periodic basis, or media devices 120 could push content data to the server 140, e.g., in real-time or near real time, on a periodic basis, and/or upon a user selection to push data to the server 140, etc. Further, the server 140 could periodically select one or more of the records of content data 130 in the data store 145 for updating, regardless of whether new data has been received from a media device 120 relating to the one or more records of content data 130. Updating could include identifying different items of media content 110 that could be grouped together according to identical or similar descriptors, e.g., a grouping could include items of media content 110 associated with descriptors such as “best comedy ever,” “top 10 comedy,” “all-time great comedy,” etc. Further, updating could include querying and/or receiving data from one or more content data sources 160, such as a social media site.

Next, in a block 310, the server 140 determines whether the item of media content 110 identified in the block 305 is already included in the content data 130 in the data store 145. However, if the item of media content 110 is not present in the data store's 145 content data 130, e.g., the item of media content 110 is identified by a media device 120 but not already included in content data 130 included in the data store 145, then the block 315 is executed next. Otherwise, the block 320 is executed next. It is to be understood that, in cases where the server 140 is selecting and/or reviewing existing records in the content data 130 in the data store 145 for updating, the block 310 may be omitted, and processing would proceed directly to the block 320.

In the block 315, the server 140 and/or the data store 145 create at least one record of content data 130 for the item of media content 110. For example, such record of content data 130 could be populated with attributes including descriptors, e.g., one or more tags indicated by a user of a media device 120, received as described above with respect to the block 305. Note that the block 315 may be optional, or even when included, may be unlikely to be frequently executed, because the data store 145 is likely to include records related to a given item of media content 110, e.g., a movie.

Following either the block 310 or the block 315, in a block 320, the server 140 searches one or more data sources for content data 130 related to the item of media content 110, e.g., according to a descriptor or other indicia of a group or category into which the item of media content 110 may fall. For example, the server 140 could query one or more content sources 105 for metadata associated with the item of media content 110, e.g., indicative of a genre, director, actor, producer, etc. Likewise, one or more content data sources 160, e.g., Facebook, Twitter, IMDb, etc., could be queried for such metadata. For example, an identifier for an item of media content 110, a name of the media content 110, etc., could be used to request information from a remote data source 160. Further, media device 120 could be configured to provide various metadata related to an item of media content 110 as described above with respect to the block 305, and additionally or alternatively could provide metadata related to an item of media content 110 in response to a query from the server 140.

Next, in a block 325, the server 140 updates attributes of the item of media content 110 in the content data 130 in the data store 145, and/or updates attributes of media content 110 groups, and may create a new media content 110 group if specified by a user. For example, descriptors or other attributes provided as described above with respect to the block 305 could be added to a record in the content data 130 relating to a media content item 110 and/or content 110 group. Further, attributes obtained as described with respect to the block 320 could be added. Moreover, a record of content data 130 may be associated with a user or group of users in addition to being associated with a particular item of media content 110. For example, in the block 305, information received from a media device 120 could include, in addition to an identifier for an item of media content 110 and one or more descriptors, an identifier for a user or group of users with whom the one or more descriptors are associated, e.g., a first user who generated tags or the like associated with the item of media content 110, another user or group of users specified by the first user, etc. In general, content data 130 may be updated to reflect various groups of media content 110 according to descriptors and other categories and/or identifiers associated with media content 110, and/or groups defined by a user, e.g., via a GUI provided by the media device 120 as discussed above.

Next, in a block 330, for each record of content data 130 added or updated, the server 140 assigns and/or updates descriptors for the item of media content 110 and the user included in the record. In some implementations, the block 330 may be omitted. However, it may be helpful to process descriptors received as described above, e.g., in the blocks 305, 320, to make content data 130 more useful. For example, various descriptors may be processed to be included in a single category or group of descriptors. For example, a first user could specify that an item of media content 110 was “hilarious,” where a second user could specify that the item of media content 110 was “very funny.” In this case, the server 140 could consult a dictionary, lookup table, etc., to include the item of media content in a “comedy” category, and moreover, to indicate this categorization in records of content data 130 associated with the item of media content 110 and the first and second users, respectively.

Further, in the block 330, other metadata of media content 110 and/or other data received from a media device 120 could be processed. For example, the media device 120 could include a timestamp or the like indicating when a user was viewing a particular item of media content 110. This timestamp could be used to perform any further categorization or grouping of the media content 110 in content data 130, e.g., “late-night.” To take another example, media content could be categorized, based on information received from a media device 120, to indicate that the entire item of media content 110 was viewed by a particular user, that only a portion was viewed, that related items of media content 110 (e.g., multiple episodes of a television series) have been viewed by the user, etc.

As mentioned above concerning the block 305, elements of the process 300 may be performed on a real-time or near real-time basis. Thus, categories of media content 110 may be created in content data 130 on a near, i.e., substantially, real-time basis. For example, content data 130 may be received in the server 140 from a media device 120 substantially in real-time upon a user's input of descriptors for an item of media content 110, e.g., “great comedy scene.” The server 140 could then, e.g., in the block 330, update content data 130 to indicate that a particular user had identified a particular item of media content as including a “great comedy scene.” Further, the server 140 could use content data 130 concerning other comedy items of media content 110 given high ratings, positive comments, etc., by the user, to identify such other comedy items of media content 110 in content data 110 for inclusion in a GUI and presentation to other users as described below. Again, such updating of content data 130 and/or an end-user GUI could be performed on an ad hoc or periodic basis, but could also be done in real-time or near real time.

Following the block 330, the process 300 ends.

FIG. 4 is a diagram of an exemplary process 400 for use of content data 130, including display information about, links to, etc., items of media content 110 in a GUI of a media device 120, as mentioned above.

The process 400 begins in a block 405, in which, according to instructions in the application 135, the media device 120 obtains content data 130 from the server 140. For example, the media device 120 may identify a user, whereupon the server 140 may query content data 130 in the data store 145 for content data 130 of interest to the user. Further, after a media device 120 establishes communications with the server 140, and provides an identifier for a particular user, the server 140 may push content data 130 to the device 120 on a real-time or near real basis, periodically, etc. Such content data may be used to generate and/or update a GUI that displays categories or descriptions applicable to items of media content 110, along with information about, links to, etc. the items of media content 110.

Content data 130 may be identified as of interest to a particular user in a variety of ways. For example, the data store 145 could include a table or the like identifying groups of items of media content 110, e.g., according to users and descriptors and/or categories of content in which the use is interested. Further, data store 145 could include tables or the like associating various users with one another, such that if a first user had an interest in an item of media content 110, or in a particular descriptor for media content 110, that item of media content 110, or and/or media content 110 having descriptors of interest to the first user could be determined to be of interest to the second user.

Next, in a block 410, the application 135 provides a GUI, such as described above, to the media device 120 for display 125. The GUI generally allows a user to browse and/or search options for viewing media content 110 according to content data 130. For example, content 110 could be organized according to various groups of media content 110, such as categories of content 110 tagged by other users, according to identifiers, e.g., usernames, icons, etc., for other users, etc. Further, information specified by a user, e.g., in a search query, could be included in the GUI. Query results could group items of media content 110 in various ways. For example, the GUI could list an item of media content 110 for a first user as having been of interest to a second user, and could also indicate a tag or tags specified by the second user. Thus, the first user could request, e.g., according to an input mechanism in the GUI, a list of other items of media content 110 so tagged by the second user. Similarly, the first user could specify to see a list of additional tags specified by the second user, and could then request to see items of media content 110 grouped according to such tags. Further, the first user could specify that groups be displayed if they included items of media content 110 associated with a second user and/or tag (e.g., “Show me all groups specified by the second user that include the movie “Forrest Gump”). Alternatively or additionally, the application 135 could include instructions for the GUI to present items of media content 110 to a first user based on groups specified to be of interest to one or more second users.

Next, in a block 415, the application 135 receives a content 110 selection according to the GUI presented in the block 410. Such content 110 may be retrieved from a content source 105.

Next, in a block 420, the selected content is played by the media device 120, e.g., displayed in the display device 125.

Following the block 420, the process 400 ends.

### Conclusion

Computing devices such as those discussed herein generally each include instructions executable by one or more computing devices such as those identified above, and for carrying out blocks or steps of processes described above. For example, process blocks discussed above may be embodied as computer-executable instructions.

Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

In the drawings, the same reference numbers indicate the same elements. Further, some or all of these elements could be changed. With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer server that includes a processor and a memory, wherein the server is configured to:
receive, from a first remote site that includes a media device configured to play media content, a first set of data relating to an item of media content, the first set of data including an identifier for the item of media content, a descriptor of the item of media content, and an identifier of a first user associated with the descriptor;
receive, from a second remote site, a second set of data concerning the item of media content;
use the first set of data and the second set of data to assign a group to the item of media content;
determine, according to data relating to a plurality of users, at least one second user to be associated with the group; and
store content data for the media content that includes the identifier for the item of media content, the group, the identifier of a first user, and an identifier of the second user.

2. The system of claim 1, wherein the server is further configured to use the content data to identify a plurality of items of media content for presentation to the second user.

3. The system of claim 2, wherein the server is further configured to transmit to a second media device data concerning the plurality of items of media content for presentation to the second user.

4. The system of claim 3, wherein the second media device is configured to display a graphical user interface based at least in part on the data concerning the plurality of items of media content for presentation to the second user.

5. The system of claim 1, wherein the server is further configured to receive data from the first remote site substantially in real-time.

6. The system of claim 1, wherein the server is further configured to receive data from first remote site while the item of media content is being played by the media device.

7. The system of claim 1, wherein the group is determined according to at least one of the descriptor and a datum in the second set of data retrieved from the second remote site.

8. The system of claim 1, wherein the first set of data includes a user-defined grouping.

9. A system, comprising a media device that includes a processor and a memory, wherein the media device is configured to:
receive from a first remote site a first set of data concerning a plurality of items of media content, wherein each of the plurality of items of media content is determined at the first remote site at least in part according to a descriptor provided from the first media device and data from a second remote site; and
display a graphical user interface identifying each of the plurality of items of media content.

10. The system of claim 8, wherein the media device is further configured to:
play an item of media content that is not included in the plurality of items of media content;
receive user input indicating a descriptor for the played item of media content; and
transmit to the remote server a second set of data including the descriptor for the played item of media content, and an identifier for the played item of media content.

11. The system of claim 8, wherein the media device is further configured to:
receive a selection to play one of the plurality of items of media content; and
play the selected one of the plurality of items of media content.

12. The system of claim 11, wherein the media device is further configured to:
play the selected one of the plurality of items of media content;
receive user input indicating a descriptor for the played one of the items of media content; and
transmit to the first remote site a second set of data including the descriptor for the played one of the items of media content, and an identifier for the played one of the items of media content.

13. The system of claim 8, wherein the media device is further configured to transmit an identifier to the first remote server, further wherein the identifier is at least one of an identifier for a user and an identifier for the media device, and each of the plurality of items of media content are determined at the first remote site at least in part according to the identifier.

14. The system of claim 8, wherein the media device is one of a set top box, a personal computer, a tablet computer, and a smartphone.

15. A method, comprising:
receiving, in a computer server that includes a processor and a memory, from a first remote site that includes a media device configured to play media content, a first set of data relating to an item of media content, the first set of data including an identifier for the item of media content, a descriptor of the item of media content, and an identifier of a first user associated with the descriptor;
receiving, from a second remote site, a second set of data concerning the item of media content;
using the first set of data and the second set of data to assign a group to the item of media content;
determining, according to data relating to a plurality of users, at least one second user to be associated with the group; and
storing content data for the media content that includes the identifier for the item of media content, the group, the identifier of a first user, and an identifier of the second user.

16. The method of claim 15, further comprising using the content data to identify a plurality of items of media content for presentation to the second user.

17. The method of claim 16, wherein the server is further configured to transmit to a second media device data concerning the plurality of items of media content for presentation to the second user.

18. The method of claim 17, wherein the second media device is configured to display a graphical user interface based at least in part on the data concerning the plurality of items of media content for presentation to the second user.

19. The method of claim 15, further comprising receiving data from the first remote site substantially in real-time.

20. The method of claim 15, further comprising receiving data from first remote site while the item of media content is being played by the media device.

21. The method of claim 15, further comprising determining the group according to at least one of the descriptor and a datum in the second set of data retrieved from the second remote site.

22. The method of claim 15, wherein the first set of data includes a user-defined grouping.
